(19) United States
(12) Patent Application Publication
(10) Pub. No.: US 2009/0152189 A1
(43) Pub. Date: Jun. 18, 2009

(54) LATERALLY SEALING GASKET INTERFACE

(75) Inventor: Jean R. Beaulieu, Cookeville, TN (US)

Correspondence Address: HAMRE, SCHUMANN, MUELLER & LARSON, P.C., P.O. BOX 2902, MINNEAPOLIS, MN, 55402-0902, US

(73) Assignee: CUMMINS FILTRATION IP, INC., Minneapolis, MN (US)

(21) Appl. No.: 11/955,110

(22) Filed: Dec. 12, 2007

(51) Int. Cl. B01D 35/30; E04B 1/682; F16J 15/02

(52) U.S. Cl. 210/348; 277/316; 277/630; 277/312

(57) ABSTRACT

A gasket interface for a fluid filter is described. The gasket interface described includes a seal disposed between plate members, where at least one of the plate members is movable with respect to the other. The seal includes a seal position and a release position. In the seal position, the seal is compressible along an axis when the plate members move toward each other, while the seal is also expandable along another axis as a result of being compressed. The seal has a laterally extending portion to provide a sealing configuration. In the release position, the seal is non-compressed when the plate members move away from each other and the laterally extending portion is withdrawn so as not to be laterally extended and be removed from the sealing configuration. The gasket interface provides a unique sealing configuration that does not require end-to-end engagement of the sealing parts.

### FIELD

A lateral sealing gasket interface is disclosed that can improve sealing ability, for example between a fluid filter and a mating surface on another component or equipment, and particularly for preventing leakage from a desired fluid flow into and out of the fluid filter.

### BACKGROUND

Seal configurations are widely known and used in a number of practical applications, and particularly with respect to fluid filter designs used in various engine applications, for example spin-on type fluid filters in engine lubrication and fuel filtration.

Typically, such fluid filters have employed gasket seals between facing end surfaces. That is, previous gasket seal(s) have been disposed between an end face of the fluid filter, such as at an outer end of the fluid filter's head and nutplate, and an end face of a mating surface, such as at an outer end of an engine block where the mating spud is disposed. Such a sealing configuration is a typical end to end, in-line (e.g. vertical) arrangement.

However, improvements can still be made to sealing configurations and their structure, particularly those used in fluid filtration to prevent leakage from the flow passage.

### SUMMARY

The following technical disclosure describes a unique gasket interface that can be helpful in providing an improved seal configuration with better mounting ability and ease of service.

The new design seals the gasket along a lateral surface rather than typical end-to-end sealing arrangements.

In one embodiment, a gasket interface includes first plate and second plate members, where at least one support member is generally disposed between the plate members. The support member is operatively engaged with the first plate member so as to be movable with respect to the first plate member. The support member is connected to the second plate member such that the second plate member is movable with respect to the first plate member when the support member moves. A seal member is disposed between the plate members, and the seal member is disposed proximate an outer perimeter of each of the plate members, the seal member is compressible in a sealing position when the support member and the second plate member move toward the first plate member, such that the seal member is laterally extendable beyond the outer perimeter of each of the plate members.

In another embodiment, a method of sealing a fluid filter to an engine component includes contacting end surfaces of a fluid filter and an engine component, where flow passages of the fluid filter and the engine component are engaged. The fluid filter is secured to the engine component so that the flow passages are arranged in a fluid flow enabling communication. During the step of securing the fluid filter to the engine component, the fluid connection between the fluid filter and the engine component is sealed. Sealing the fluid connection comprises compressing a seal member between two plate members along an axis defined by a direction in which the fluid filter and engine component face each other in an end-to-end arrangement, and expanding the seal member along another axis defined transversely with respect to the end-to-end arrangement of the fluid filter and engine component. Expanding the seal member includes laterally extending the seal member beyond outer perimeters of the two plate members, and contacting side surfaces of the engine component relative to the end surface of the engine component.

As one practical application, the disclosure herein provides a new gasket design that allows a spin-on type fluid filter to seal laterally against a side surface of an engine block when connecting to its spud, rather than sealing between end faces of the fluid filter and the engine block.

### BRIEF DESCRIPTION OF THE DRAWINGS

FIG. 1 illustrates a schematic partial side sectional view of one embodiment of a gasket interface and showing the interface before being positioned in a sealing engagement.

FIG. 2 illustrates a schematic partial side sectional view of the gasket interface of FIG. 1 and showing the interface after being positioned in a sealing engagement.

FIG. 3 illustrates a perspective and partially exploded view of another embodiment of a gasket interface with a fluid filter.

FIG. 4 illustrates a known spin-on type fluid filter.

### DETAILED DESCRIPTION

The following description generally provides an improved sealing structure and configuration. For example, a gasket interface with a particular seal is described that can seal the gasket interface along a lateral direction. In one practical application, the gasket interface is used as an attachment to a spin-on type fluid filter, for example in engine oil or fuel filtration applications. The gasket interface is particularly useful for sealing against a side surface of an engine block when connecting to its spud, rather than sealing between end faces of the fluid filter and the engine block.

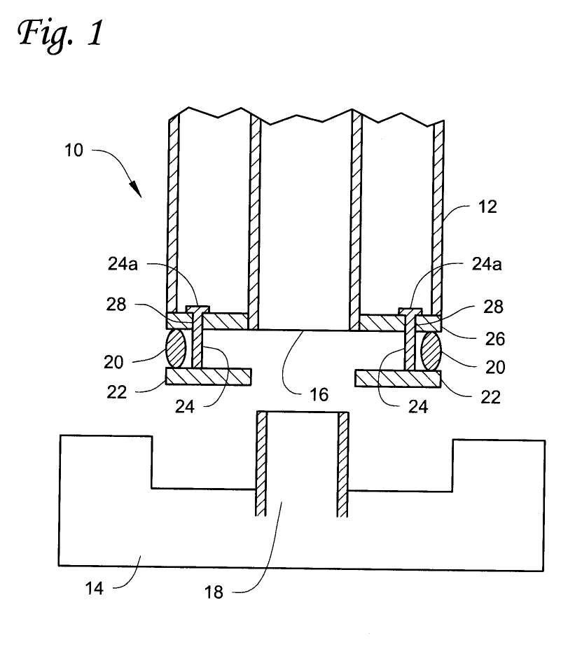

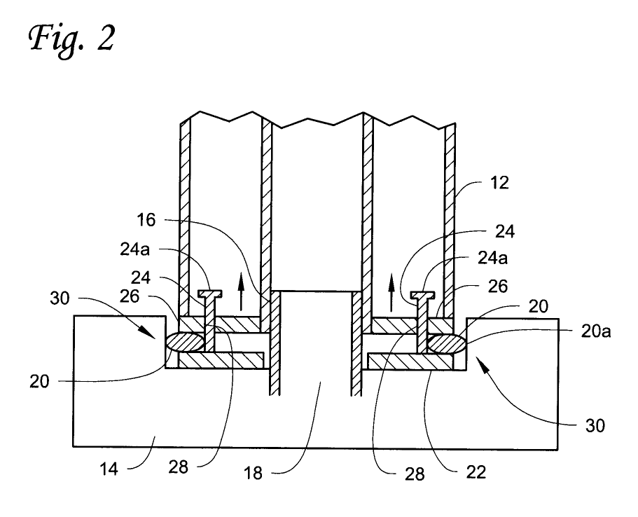

FIGS. 1 and 2 illustrate one embodiment of a gasket interface 10. As shown, the gasket interface 10 includes a seal member 20 disposed between a first plate member 26 and a second plate member 22. At least one support member 24 is disposed between the first plate member 26 and the second plate member 22. The first plate member 26 is operatively engaged to the support member 24, such that the support member 24 is movable with respect to the first plate member 26. As shown, the first plate member 26 in one embodiment includes openings 28 therethrough, which are receivable of the support member 24. The support member 24 is connected to the second plate member 22, such that the second plate member 22 is movable with respect to the first plate member 26 when the support member 24 moves with respect to the first plate member 26. As one example, the plate members 22, 24 and the support member 24 are formed of a rigid material, such as a metal or a composite material suitable for engine filtration systems.

In one embodiment, the support member 24 may be freely slidable within the opening 28 of the first plate member 26, so long as the support member 24 does not become disengaged with the first plate member 26 when in use. The support member 24 may be connected to the first plate member 26 in a number of ways to accomplish this result. As shown in FIGS. 1 and 2, for example, the support member 24 includes a structure 24a that may be a barb, rivet, or catch. The structure 24a is disposed at the end of the support member 24 opposite the end connecting to the second plate member 22, and also where the barb, rivet, or catch is disposed on the other side of the opening 28 facing away from the second plate member 22. The structure 24a may be a part that is separately connected to the support member 24, and the order of assembly of the first and second plate member 22, 26, support member 24, and structure 24a may be accomplished any number of ways. The support member 24 may be fixed to second plate member 22.

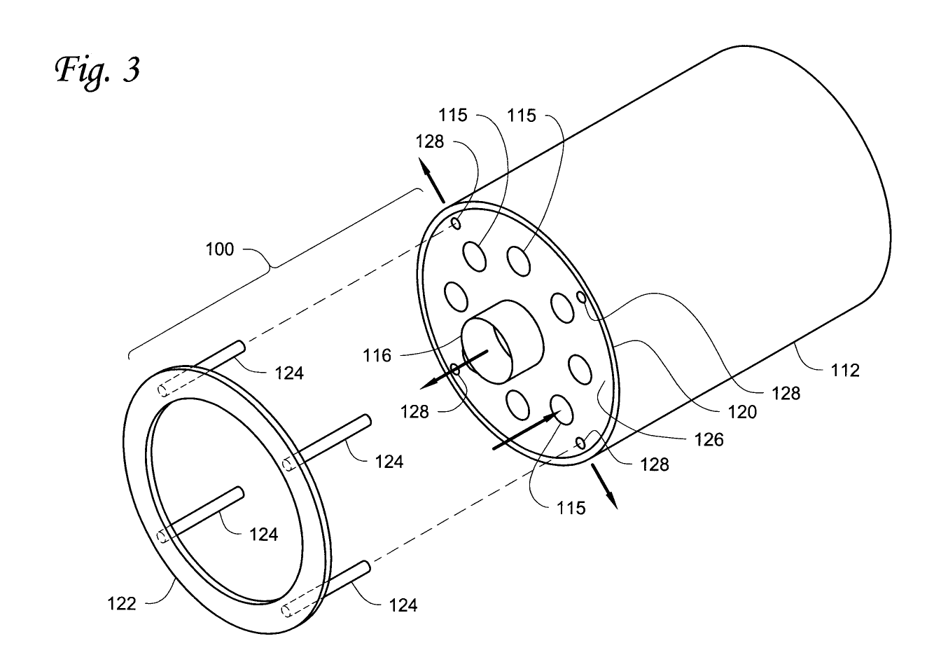

FIGS. 1 and 2 show that the gasket interface 10 includes two support members 24. In one embodiment, the support member 24 includes a width or diameter with a dimension that is about the same dimension as the width or diameter of the opening 28, so as to be able to slide or move therein. Accordingly, the first plate member 26 includes two openings 28 receivable of the two support members 24. It will be appreciated, however, that the support member 24 may be constructed as a generally single cylindrical member that is receivable in one generally circular opening of the first plate member 26. Likewise, it further will be appreciated that the gasket interface 10 may include more than one or more than two support members 24 with corresponding openings 28. For example, the gasket interface 10 may include three, four, or more support members 24 and corresponding openings 28. In yet another embodiment, the support members 24 are generally cylindrical pins and the openings 28 are generally cylindrical holes, where the pins have a diameter about the same diameter as the holes, so that they may slide into the holes. (See e.g. embodiment shown in FIG. 3 below.) However, it will be appreciated that the number and shape of the support member 24 and opening 28 may be modified as needed or desired according to its particular application, as long as any configuration employed is not inconsistent with the inventive concepts described herein.

In one embodiment, the first plate member 26 and the second plate member 22 are generally cylindrical plates. In such a configuration, the plate members 22, 26 may be ideal for attachment to a fluid filter 12, for instance spin-on type fluid filters as may be known in the art. However, it will be appreciated that the shape of the plate members 22, 26 may be modified as needed or desired according to its particular application, as long as any configuration employed is not inconsistent with the inventive concepts described herein.

As shown, the seal member 20 is disposed between the first plate member 26 and the second plate member 22. The seal member 20 is disposed proximate an outer perimeter defined by both the first and second plate members 26, 22. The seal member 20 may be retained between the first and second plate members 26, 22 in a variety of ways. As one example, the seal member 20 may be suitably affixed to either the first or second plate members 26, 22 through a thermal, adhesive bond or through suitable weld techniques. Also, where the seal member 20 is generally a ring-like structure, then the seal member 20 may be retained since it is disposed around the support member 24. As another example, the second plate member 22 and support member 24 may be arranged and configured with respect to the first plate member 26, so as to only allow the second plate member 22 to move away from the first plate member a limited distance to hold the seal member 20 between the plate members 26, 22.

FIGS. 1 and 2 respectively show schematic partial side sectional views of the gasket interface 10 before being positioned in a sealing engagement and after being positioned in a sealing engagement. In the example shown, the gasket interface 10 is suited for connecting a fluid filter 12 to another component or equipment 14 of a filtration system, where the second plate member 22 is guided to come into contact with a surface of the component or equipment 14. As shown, the gasket interface 10 is connected to a fluid filter 12, for example a spin-on type fluid filter, and acts as an attachment for connecting and sealing the fluid filter 12 to the component or equipment 14. As one example, the component or equipment 14 is an engine block 14 as may be known in the art, and has a spud 18 for connecting to the fluid filter 12. The engine block 14 and the fluid filter 12 are releasably connected between an outer side of the spud 18 and an inner side of the fluid filter where the opening 16 is disposed. It will be appreciated that the engine block 14 (i.e. spud 18) and the fluid filter 12 may be connected using a variety of known connection structures, for example a threaded engagement (not shown) between the outer side of the spud 18 and an inner surface of the fluid filter 12.

Likewise, both the first plate member 26 and second plate member 22 include openings therethrough, which may be configured to align with each other and with an opening 16 of the fluid filter 12. The openings are aligned enough such that they are in fluid communication to allow fluid to exit the fluid filter 12. Accordingly, the fluid filter 12, the gasket interface 10 and the spud 18 of the engine block 14 are connected in fluid communication with each other so that filtered fluid can exit the fluid filter 12 (FIG. 2) into the engine block 14. It will be appreciated that the first plate member 26 also includes inlet passages so that fluid to be filtered may enter the fluid filter 12 (not shown in FIGS. 1 and 2, but shown in FIG. 3 described below). It further will be appreciated that entry of fluid to be filtered into the fluid filter 12 may be accomplished in a variety of ways, as may be known for example in spin-on fluid filters. One such example is illustrated in FIG. 3, which is described below.

In operation, as the fluid filter 12 is connected (i.e. or spun on) to the component 14, the second plate member 22 is guided toward the first plate member 26 and fluid filter 12 and compresses the seal member 20 (FIG. 2). The second plate member 22 may act as a compression plate when moving to compress the seal member 20 against the first plate member 26. The seal member 20 expands laterally thereby creating sealing areas 30 on side surfaces of the engine block 14. In one embodiment, the seal member 20 is compressible in a sealing position when the fluid filter 12 is secured to the engine block 14, such that support member 24 and the second plate member 22 move toward the first plate member 26. As a result, the seal member 20 is laterally extendable beyond the outer perimeter or outer sides of the first and second plate members 26, 22.

In one embodiment, the seal member 20 is a flexible material that is configured to be compressible along an axis defined by a direction of the support member 24 extending from the first plate member 26 to the second plate member 22. The seal member 20 is configured to be expandable along another axis that is transverse to the axis defined by the direction of the support member 24. As one example only, the seal member 20 is constructed and arranged to have a first end-to-end dimension that is greater than a second end-to-end dimension when at rest. In one embodiment, the first end-to-end dimension of the seal member 20 faces the first and second plate members 26, 22, and the second end-to-end dimension faces the support member 24 and faces away from the opening 16 or toward an outer perimeter defined by the first and second plate members 26, 22.

As some examples only, the seal member 20 may be constructed of a resilient, flexible material, such as but not limited to a nitrile material, Vamac®, and hydrogenated nitrile butadiene rubber (HNBR), or the like, as typically used in lube application filtration. Likewise, a nitrile material, fluorocarbon material, and fluorosilicone material, or the like may be employed as a seal material in fuel filter applications. It will be appreciated that the materials listed are non-limiting, and that other suitable materials may be used that can accomplish the sealing function described.

In yet another embodiment, the seal member 20 may resemble a generally o-ring seal disposed between the plate members 22, 26 and proximate an outer perimeter of the plate members. In FIGS. 1 and 2, the seal member 20 is shown in section. As a result of the second plate member 22 moving toward and away from the first plate member 26, the seal member 20 has a seal engaging position and a seal releasing position. The seal engaging position is when the seal member 20 is compressed along the axis when the two plate members 26, 22 are closer to each other. In the seal engaging position, the seal member 20 is also expandable along the transverse axis as a result of being compressed. When expanded, the seal member 20 has a laterally extending portion 20a that extends beyond outer perimeters or outer sides of the two plate members 22, 26. In the seal releasing position, the seal member 20 is non-compressed as a result of the gasket interface 10 (and fluid filter 12) being disconnected with the engine block 14. In this position, the two plate members 26, 22 have moved away from each other, such that the laterally extending portion 20a may be withdrawn so as not to extend beyond the outer perimeters or outer sides of the two plate members 22, 26. That is, the seal member 20 may be released from compression and it may return to its uncompressed, at rest state.

As discussed, the gasket interface 10 can be an attachment to the fluid filter 12. FIGS. 1 and 2 show a portion of the fluid filter 12. It would be appreciated that the fluid filter 12 in some cases is a spin-on type fluid filter as may be known in the art, and would include a housing having a closed end and an end configured with certain openings or flow passages to receive fluid to be filtered and configured to allow filtered fluid to exit. The fluid filter 12 also includes a filter component disposed within the housing, and configured to filter fluid that enters the housing and allow the filtered fluid to exit the housing. It will be appreciated that such fluid filters are well known, and are not further described.

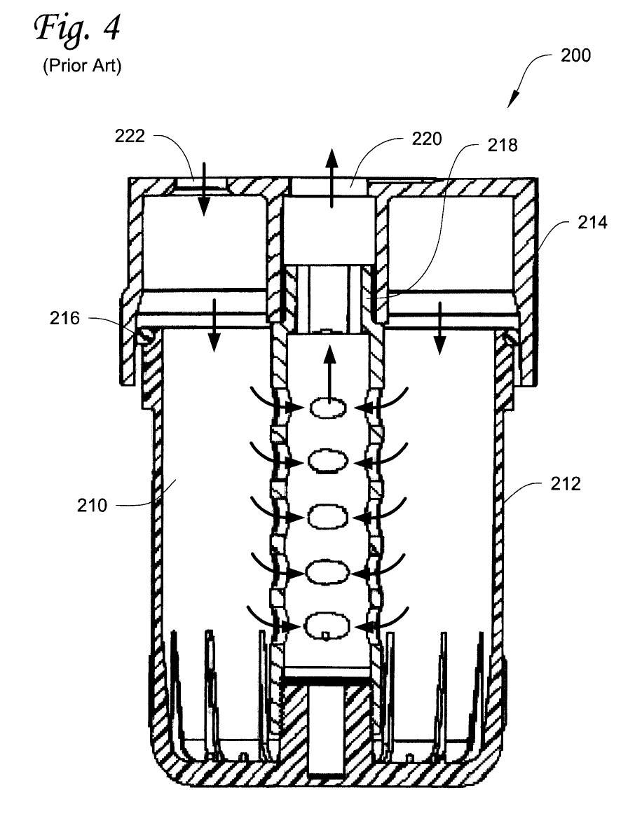

In one embodiment, the gasket interface 10 is mounted on an end surface of the fluid filter 12 as a separate attachment. For example, when the gasket interface 10 is used with a spin-on type fluid filter as may be known, the gasket interface may be mounted on the outer end face of a filter head or nutplate of the filter. In such fluid filters, the filter head or nutplate is generally disposed at the open end of the filter housing, and is configured to generally close the housing and to put a flow passage of the fluid filter to a flow passage of another equipment (e.g. spud 18 of engine block 14) in fluid communication. In such a configuration, the gasket interface 10 may by connected on top of the filter head or nutplate such that openings of the gasket interface 10 are in fluid communication with the flow passages (inlet, outlet) of the filter head or nutplate. FIG. 4 shows an example of a known spin-on type fluid filter and is described below.

It also will be appreciated that in other embodiments, the filter head of such fluid filters may be modified such that the gasket interface 10 is incorporated as part of the fluid filter. For example, filter head structure, such as the nutplate may act as the first plate member 26 of the gasket interface 10. In such a configuration, the nutplate can be suitably modified to support the seal member and the support member 24 so as to operate as the first plate member, rather than the gasket interface 10 being mounted on the fluid filter as a separate attachment.

As further shown in FIGS. 1 and 2, a method of sealing a fluid filter 12 to an engine component (e.g. engine block 14) includes contacting an end surface of a fluid filter 12 to an end surface of an engine component. The fluid filter 12 is connected to the engine component so that the flow passage of the fluid filter 12 is arranged in a fluid flow enabling communication with the flow passage of the engine component (i.e. spud 18). During connection of the fluid filter 12 to the engine component, a seal between the fluid filter 12 and the engine component also occurs. Sealing the fluid filter 12 and the engine component includes compressing the seal member 20 between the two plate members 26, 22 along an axis defined by a direction in which the fluid filter 12 and engine component face each other in an end to end arrangement. The seal member 20 is expanded along another axis defined transversely with respect to the end to end arrangement of the fluid filter 12 and engine component. Expanding the seal member 20 includes laterally extending the seal member 20 beyond outer perimeters of the two plate members 26, 22, and contacting the laterally extending portion 20a with shoulder surfaces (i.e. sealing areas 30) of the engine component. The shoulder surfaces being relative to the end surface of the engine component.

In one embodiment, the steps of compressing and expanding the seal member 20 occur simultaneously, in which expanding the seal member 20 includes forming a laterally extended portion 20a while compressing the seal member 20.

Turning to FIG. 3, a fluid filter 112 is shown with a gasket interface 100. The gasket interface 100 includes a first plate member 126 and a second plate member 122. Support members 124 are shown as generally cylindrical pins that are connected to the second plate member 122 and that correspond to holes 128 of the first plate member 126. As described, the support members 124 may be received by and slide within the holes 128, so that the second plate member 122 and support members 124 may move with respect to the first plate member 126. As shown, the seal member 120 is disposed on the first plate member 126 and would be between the first and second plate members 122, 126, when the second plate member 122 and support members 124 are connected with the first plate member 126 (see dotted lines). The seal member 120 may be connected to the first plate member 126 in a variety of ways as already described. It will be appreciated that the seal member 120 may also be connected to the second plate member 122 rather than the first plate member 126. The arrows directed outward from the seal member 120 show the direction that the seal member 120 may be expanded when sealing is desired.

FIG. 3 shows the first plate member 126 being connected to one end of the fluid filter 112. As described, it will be appreciated that the first plate member 126 may be a plate member that is a separate part from the filter head, such as in the case where the gasket interface is a separate attachment to the fluid filter, or the first plate member may be a modified nutplate, such as in the case where the filter head structure includes a structure that serves as the first plate member.

FIG. 3 shows an exemplary flow configuration that illustrates the flow into and out of the fluid filter 112, as well as through the first plate member 126 of the gasket interface. Opening 116 shows an outlet configuration for allowing filtered fluid to exit the fluid filter 112. Openings 115 show an inlet configuration for allowing fluid to be filtered to enter the fluid filter 112. The flow of fluid within the fluid filter 112 is not particularly limited to any configuration, and may be designed in a variety of ways as may be known in the art, as long as an inlet is provided for fluid to enter the fluid filter and be filtered, and as long as an outlet is provided for filtered fluid to exit the fluid filter.

FIG. 4 shows an example of a known spin-on type filter with which the gasket interface may be employed. Spin-on filter 200 includes a nutplate 214 that has been employed for diverting flow into 222 and out of 220 a filter media 210. A sealing structure required in such filters generally is a seal 216 around the outer edge of the housing and between a housing 212 and nutplate 214. An additional seal 218 is disposed around the attaching spud and between the spud and the nutplate 214. The nutplate 214 may be suitably modified to support the gasket interface 10 as a separate attachment, where the first plate member may be mounted on the nutplate 214, and the nutplate 214 would include opening(s) to provide clearance for the support member(s) 24 to move as described. Likewise, the nutplate 214 may be modified to serve as the first plate member, where the nutplate would include opening(s) to provide clearance for the support member(s) 24 to move as described. In such a configuration, a separate plate member is not needed since the nutplate of the fluid filter may be used as the first plate member.

As discussed, traditional filter gaskets seal along the end face surfaces of the components to be sealed (i.e. vertically arranged seal). However, the gasket interface arrangement and structure described herein seals along lateral surfaces, such as lateral surfaces of a fluid filter (e.g. spin-on type fluid filter) and an engine component (e.g. engine block). Such a gasket interface as described above may provide significant aftermarket benefits, in its ease of service. The sealing configuration also does not apply a direct load as in the typically used end-to-end contact between components, and such a configuration may avoid working against the seal and compromising it.

The inventive concepts disclosed herein may be embodied in other forms without departing from the spirit or novel characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A gasket interface comprising:
a first plate member;
a second plate member;
at least one support member generally disposed between the first and second plate members, the support member operatively engaged with the first plate member so as to be movable with respect to the first plate member, the support member connected to the second plate member such that the second plate member is movable with respect to the first plate member when the support member moves with respect to the first plate member; and
a seal member disposed between the first and second plate members, the seal member is compressible in a sealing position when the support member and the second plate member move toward the first plate member, such that the seal member is laterally extendable beyond an outer perimeter defined by the first and second plate members.

2. The gasket interface of claim 1, wherein the first and second plate members each comprise an opening therethrough, such that the openings are aligned with each other.

3. The gasket interface of claim 1, wherein the first plate member comprises at least one opening for each support member, the opening configured to receive the support member.

4. The gasket interface of claim 1, wherein the support member comprises a generally slidable member operatively engaged with the first plate member and configured to be slidable relative to the first plate member.

5. The gasket interface of claim 1, wherein the seal member is a generally flexible material and the seal member is configured to be compressible along an axis defined by a direction of the support member extending from the first plate member to the second plate member, and the seal member is configured to be expandable along another axis that is transverse to the axis defined by the direction of the support member.

6. The gasket interface of claim 1, wherein the seal member is constructed and arranged to have a first end-to-end dimension that is greater than a second end-to-end dimension, the first end-to-end dimension comprising the seal member facing the first and second plate members, the second end-to-end dimension comprising the seal member facing the support member and facing toward an outer perimeter defined by the first and second plate members.

7. The gasket interface of claim 1, wherein the seal member is generally disposed proximate the outer perimeter defined by both the first and second plate members.

8. A fluid filter comprising:
a housing having a closed end and a generally open end configured to receive fluid to be filtered and exit filtered fluid;
a filter component disposed within the housing, the filter component configured to filter fluid that enters the housing and allow the filtered fluid to exit the housing;
a filter head generally disposed at the generally open end, the filter head configured to generally close the housing and configured to allow a flow passage of the fluid filter to be in fluid communication with a flow passage of another equipment; and
a gasket interface disposed on an outer end of the filter head, the gasket interface comprising a first plate member and a second plate member, at least one support member generally disposed between the first and second plate members, the support member operatively engaged with the first plate member so as to be movable with respect to the first plate member, the support member connected to the second plate member such that the second plate member is movable with respect to the first plate member when the support member moves with respect to the first plate member; and a seal member disposed between the first and second plate members, the seal member is compressible in a sealing position when the support member and second plate member move toward the first plate member, such that the seal member is laterally extendable beyond an outer perimeter defined by the first and second plate members.

9. The fluid filter of claim 8, wherein the first and second plate members each comprise an opening therethrough, such that the openings are aligned with each other and are in fluid communication with the filter component and the filter head.

10. The fluid filter of claim 8, wherein the first plate member comprises at least one opening for each support member, the opening configured to receive the support member.

11. The fluid filter of claim 8, wherein the support member comprises a generally slidable member operatively engaged with the first plate member and configured to be slidable relative to the first plate member.

12. The fluid filter of claim 8, wherein the seal member is a generally flexible material and the seal member is configured to be compressible along an axis defined by a direction of the support member extending from the first plate member to the second plate member, and the seal member is configured to be expandable along another axis that is transverse to the axis defined by the direction of the support member.

13. The fluid filter of claim 8, wherein the seal member is constructed and arranged to have a first end-to-end dimension that is greater than a second end-to-end dimension, the first end-to-end dimension comprising the seal member facing the first and second plate members, the second end-to-end dimension comprising the seal member facing the support member and facing an outer perimeter of the first and second plate members.

14. The fluid filter of claim 8, wherein the seal member is generally disposed proximate the outer perimeter defined by both the first and second plate members.

15. The fluid filter of claim 8, wherein the first plate member is configured as a nutplate of the filter head.

16. The fluid filter of claim 8, wherein the fluid filter is a spin-on type fluid filter.

17. A filter attachment comprising:
a filter head component configured to connect to a fluid filter, the filter head configured to allow a flow passage of the fluid filter to be in fluid communication with a flow passage of another equipment;
a seal component including a seal member disposed between two plate members; the plate members are movable with respect to one another; the seal member including a seal engaging position and a seal releasing position; the seal engaging position comprising the seal member being compressible along an axis when the two plate members move toward each other, and that the seal member being expandable along another axis as a result of being compressed, the seal member having a laterally extending portion beyond outer perimeters defined by the two plate members, the seal releasing position comprising the seal member being non-compressed when the two plate members move away from each other, such that the laterally extending portion being withdrawn so as not to extend beyond the outer perimeters defined by the two plate members.

18. A seal component comprising:
a seal member disposed between two plate members;
the plate members are movable with respect to one another;
the seal member including a seal engaging position and a seal releasing position;
the seal engaging position comprising the seal member being compressible along an axis when the two plate members move toward each other, and that the seal member being expandable along another axis as a result of being compressed, the seal member having a laterally extending portion beyond outer perimeters defined the two plate members, the seal releasing position comprising the seal member being non-compressed when the two plate members move away from each other, such that the laterally extending portion being withdrawn so as not to extend beyond the outer perimeters defined by the two plate members.

19. A method of sealing a fluid filter to an engine component comprising:
contacting an end surface of a fluid filter to an end surface of an engine component;
securing the fluid filter to the engine component so that a flow passage of the fluid filter is arranged in a fluid enabling communication with a flow passage of the engine component; and
sealing the fluid filter to the engine component, during securing the fluid filter to the engine component,
sealing the fluid connection comprising
compressing a seal member between two plate members along an axis defined by a direction in which the fluid filter and engine component face each other in an end to end arrangement, and
expanding the seal member along another axis defined transversely with respect to the end to end arrangement of the fluid filter and engine component, expanding the seal member including laterally extending the seal member beyond outer perimeters defined by the two plate members, and contacting shoulder surfaces of the engine component relative to the end surface of the engine component.

20. The method of claim 19, wherein compressing and expanding the seal member occur simultaneously.
